(19) United States
(12) Patent Application Publication
(10) Pub. No.: US 2008/0075024 A1
(43) Pub. Date: Mar. 27, 2008

(54) Portable electronic apparatus

(75) Inventors: Bin-Yi Chuang, Taipei (TW); Yu-Hua Chang, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 11/902,738

(22) Filed: Sep. 25, 2007

(30) Foreign Application Priority Data
Sep. 27, 2006 (TW) 095135673

(51) Int. Cl. H04B 7/00; H04B 1/38

(52) U.S. Cl. 370/310; 455/573

(57) ABSTRACT

The invention discloses a portable electronic apparatus selectively electrically connecting with a dock, wherein the dock comprises a network interface coupled to an internet. The portable electronic apparatus includes a micro controller unit and a wireless communication module. The micro controller unit is selectively electrically connected to the network interface of the dock. The wireless communication module is coupled to the micro controller unit and used for transmitting signals between a first electronic apparatus and a second electronic apparatus. When the portable electronic apparatus is electrically connected to the dock, the wireless communication module will communicate with the internet via the micro controller unit and the network interface, such that at least one of the first and second electronic apparatuses is capable of communicating with the internet via the portable electronic apparatus.

### BACKGROUND OF THE INVENTION

1. Field of the invention

The invention relates to a portable electronic apparatus and, more particularly, to a portable electronic apparatus which can be used as a router or gateway.

2. Description of the Prior Art

As technology advanced, most of the general home appliances (e.g. television, refrigerator, washing machine, etc.) or information products (e.g. mobile phone, printer, etc.) have been gradually moved toward digital development. At present, each digital home needs to install a router or gateway for connecting with each of the digital apparatuses therein. In general, the digital home utilizes an access point (AP) with function of router or gateway to connect with each of the digital apparatuses, so as to achieve wireless communication network. Furthermore, each digital apparatus has to be equipped with a built-in wireless module. However, the cost will be raised due to the additional AP and wireless module, and then the development of the digital home will be hindered.

On the other hand, the calculating capability of the portable electronic apparatus gets more and more powerful, and the wireless broadband environment gets more and more mature. If the function of router or gateway can be integrated into the portable electronic apparatus, it will be more practical and convenient for the user. Accordingly, the cost of establishing a digital home can be reduced.

Therefore, the scope of the invention is to provide a portable electronic apparatus with function of router or gateway to solve the aforesaid problems.

### SUMMARY OF THE INVENTION

A scope of the invention is to provide a portable electronic apparatus with function of router or gateway. It is more practical and convenient for the user, and the cost of establishing a digital home can be reduced accordingly.

According to an embodiment of the invention, the portable electronic apparatus selectively electrically connects with a dock. The dock comprises a network interface coupled to an internet. The portable electronic apparatus comprises a micro controller unit and a wireless communication module. The micro controller unit is selectively electrically connected to the network interface of the dock. The wireless communication module is coupled to the micro controller unit and used for transmitting signals between a first electronic apparatus and a second electronic apparatus.

In this embodiment, when the portable electronic apparatus is electrically connected to the dock, the wireless communication module will communicate with the internet via the micro controller unit and the network interface, such that at least one of the first and second electronic apparatuses is capable of communicating with the internet via the portable electronic apparatus.

Therefore, according to the portable electronic apparatus of the invention, when the user is back home and places the portable electronic apparatus onto the dock, all of the electronic apparatuses in the home not only can communicate with each other via the wireless communication module of the portable electronic apparatus but also can communicate with the internet via the portable electronic apparatus and the dock, so as to connect with the internet in wireless.

The advantage and spirit of the invention may be understood by the following recitations together with the appended drawings.

### BRIEF DESCRIPTION OF THE APPENDED DRAWINGS

FIG. 1 is a functional block diagram illustrating a portable electronic apparatus electrically connected to a dock according to a first embodiment of the invention.

FIG. 2 is a functional block diagram illustrating a portable electronic apparatus electrically connected to the dock according to a second embodiment of the invention.

FIG. 3 is a functional block diagram illustrating a portable electronic apparatus according to a third embodiment of the invention.

### DETAILED DESCRIPTION OF THE INVENTION

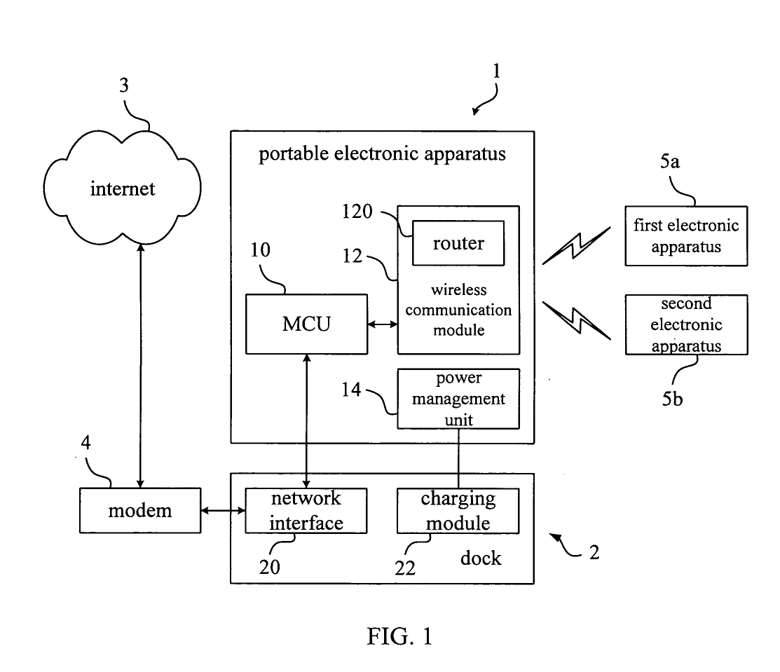

Please refer to FIG. 1. FIG. 1 is a functional block diagram illustrating a portable electronic apparatus 1 electrically connected to a dock 2 according to a first embodiment of the invention. As shown in FIG. 1, the portable electronic apparatus 1 can selectively electrically connect with the dock 2. The dock 2 comprises a network interface 20 and a charging module 22. The network interface 20 is coupled to an internet 3. In this embodiment, the portable electronic apparatus 1 can be a mobile communication apparatus, such as mobile phone, personal digital assistance (PDA), etc. The dock 2 can be a charger in relation to the portable electronic apparatus 1. The network interface 20 can be an Ethernet interface and communicates with the internet 3 via a modem 4.

As shown in FIG. 1, the portable electronic apparatus 1 comprises a micro controller unit (MCU) 10, a wireless communication module 12, and a power management unit 14. The MCU 10 is selectively electrically connected to the network interface 20 of the dock 2. The wireless communication module 12 is coupled to the MCU 10 and comprises a router 120. The router 120 is used for transmitting signals between a first electronic apparatus 5a and a second electronic apparatus 5b. In other words, the first electronic apparatus 5a can transmit signals to the second electronic apparatus 5b via the router 120 of the wireless communication module 12 of portable electronic apparatus 1, and vice versa.

In this first embodiment, when the user is back home and places the portable electronic apparatus 1 onto the dock 2, the portable electronic apparatus 1 will electrically connect with the dock 2. Afterward, the wireless communication module 12 communicates with the internet 3 via the MCU 10 and the network interface 20, such that at least one of the first and second electronic apparatuses 5a, 5b is capable of communicating with the internet 3 via the portable electronic apparatus 1. At the same time, the charging module 22 of the dock 2 will charge the power management unit 14 of the portable electronic apparatus 1. Accordingly, when the user is back home, the electronic apparatuses 5a, 5b in the home can not only communicate with each other via the router 120 of the wireless communication module 12 of the portable electronic apparatus 1 but also communicate with the internet 3 via the portable electronic apparatus 1 and the dock 2, so as to connect with the internet in wireless.

In this first embodiment, the router 120 can be selectively replaced by a gateway.

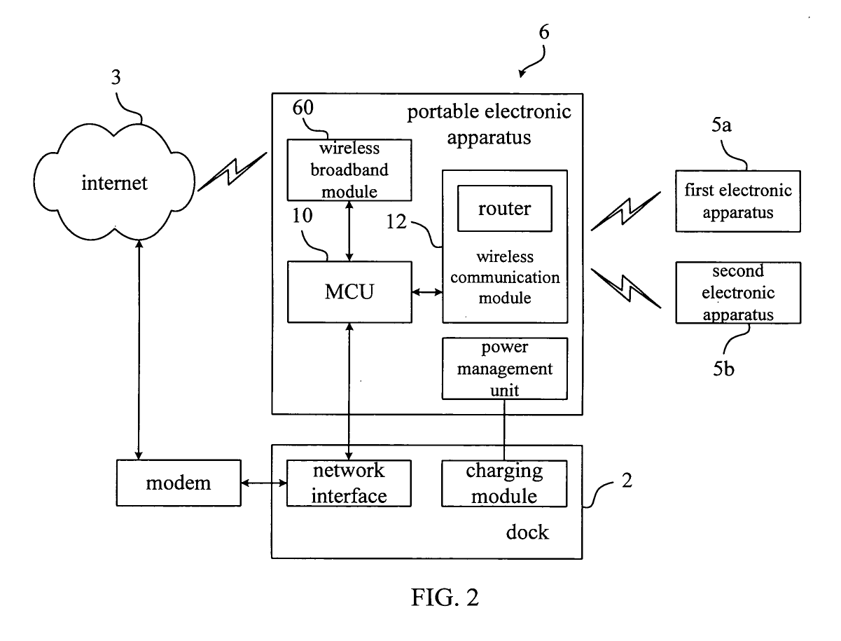

Please refer to FIG. 2. FIG. 2 is a functional block diagram illustrating a portable electronic apparatus 6 electrically connected to the dock 2 according to a second embodiment of the invention. As shown in FIG. 2, the main difference between the portable electronic apparatus 6 and the portable electronic apparatus 1 is that the portable electronic apparatus 6 further comprises a wireless broadband module 60 coupled to the MCU 10. In this embodiment, when the portable electronic apparatus 6 is not electronically connected to the dock 2, the wireless communication module 12 may communicate with the internet 3 via the MCU 10 and the wireless broadband module 60, such that at least one of the first and second electronic apparatuses 5a, 5b is capable of communicating with the internet 3 via the portable electronic apparatus 6.

Accordingly, even if the portable electronic apparatus 6 is not electronically connected to the dock 2, the first and second electronic apparatuses 5a, 5b also can communicate with the internet 3 via the wireless broadband module 60 of the portable electronic apparatus 6. The operation of the portable electronic apparatus 6 shown in FIG. 2 is the same as the portable electronic apparatus 1 shown in FIG. 1 except for the wireless broadband module 60, and the related description will not be mentioned again here.

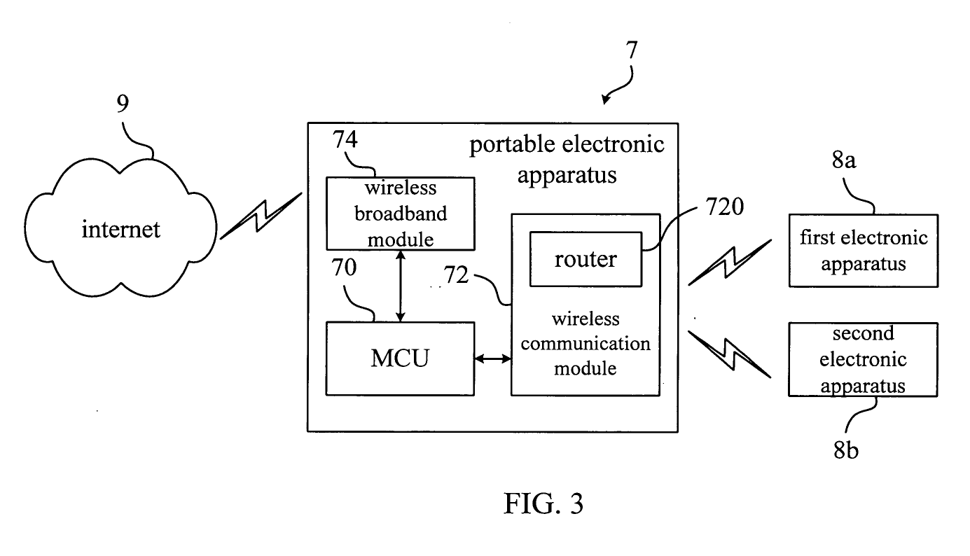

Please refer to FIG. 3. FIG. 3 is a functional block diagram illustrating a portable electronic apparatus 7 according to a third embodiment of the invention. As shown in FIG. 3, the portable electronic apparatus 7 comprises an MCU 70, a wireless communication module 72, and a wireless broadband module 74. The wireless communication module 72 is coupled to the MCU 70 and comprises a router 720. The router 720 is used for transmitting signals between a first electronic apparatus 8a and a second electronic apparatus 8b. The wireless broadband module 74 is coupled to the MCU 70 and used for communicating with an internet 9, such that at least one of the first and second electronic apparatuses 8a, 8b is capable of communicating with the internet 9 via the wireless communication module 72, the MCU 70, and the wireless broadband module 74 of the portable electronic apparatus 7.

Accordingly, when the user is back home, the electronic apparatuses 8a, 8b in the home can not only communicate with each other via the router 720 of the wireless communication module 72 of the portable electronic apparatus 7 but also communicate with the internet 9 via the wireless broadband module 74 of the portable electronic apparatus 7, so as to connect with the internet in wireless.

In this third embodiment, the router 720 can be selectively replaced by a gateway.

Compared to the prior art, according to the portable electronic apparatus of the invention, when the user is back home and places the portable electronic apparatus onto the dock, all of the electronic apparatuses in the home can not only communicate with each other via the wireless communication module of the portable electronic apparatus but also communicate with the internet via the portable electronic apparatus and the dock, so as to connect with the internet in wireless. Furthermore, even if the portable electronic apparatus is not electronically connected to the dock, the electronic apparatuses also can communicate with the internet via the wireless broadband module of the portable electronic apparatus. Accordingly, due to the portable electronic apparatus of the invention with function of router or gateway, it is more practical and convenient for the user, and the cost of establishing a digital home can be reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A portable electronic apparatus for selectively electrically connecting with a dock, the dock comprising a network interface coupled to an internet, the portable electronic apparatus comprising:
a micro controller unit selectively electrically connected to the network interface of the dock; and
a wireless communication module, coupled to the micro controller unit, for transmitting signals between a first electronic apparatus and a second electronic apparatus;
wherein when the portable electronic apparatus is electrically connected to the dock, the wireless communication module communicates with the internet via the micro controller unit and the network interface, such that at least one of the first and second electronic apparatuses is capable of communicating with the internet via the portable electronic apparatus.

2. The portable electronic apparatus of claim 1, wherein the dock is a charger.

3. The portable electronic apparatus of claim 1, further comprising a power management unit, and the dock further comprising a charging module, wherein when the portable electronic apparatus is electrically connected to the dock, the charging module charges the power management unit.

4. The portable electronic apparatus of claim 1, wherein the network interface is an Ethernet interface.

5. The portable electronic apparatus of claim 1, wherein the network interface communicates with the internet via a modem.

6. The portable electronic apparatus of claim 1, wherein the wireless communication module comprises a router for transmitting signals between the first and second electronic apparatuses.

7. The portable electronic apparatus of claim 1, wherein the wireless communication module comprises a gateway for transmitting signals between the first and second electronic apparatuses.

8. The portable electronic apparatus of claim 1, further comprising a wireless broadband module coupled to the micro controller unit, wherein when the portable electronic apparatus has not been electronically connected to the dock yet, the wireless communication module communicates with the internet via the micro controller unit and the wireless broadband module, such that at least one of the first and second electronic apparatuses is capable of communicating with the internet via the portable electronic apparatus.

9. A portable electronic apparatus comprising:
a micro controller unit;
a wireless communication module, coupled to the micro controller unit, for transmitting signals between a first electronic apparatus and a second electronic apparatus; and
a wireless broadband module, coupled to the micro controller unit, for communicating with an internet, such that at least one of the first and second electronic apparatuses is capable of communicating with the internet via the wireless communication module, the micro controller unit, and the wireless broadband module of the portable electronic apparatus.

10. The portable electronic apparatus of claim 9, wherein the wireless communication module comprises a router for transmitting signals between the first and second electronic apparatuses.

11. The portable electronic apparatus of claim 9, wherein the wireless communication module comprises a gateway for transmitting signals between the first and second electronic apparatuses.

12. The portable electronic apparatus of claim 9, the portable electronic apparatus selectively electrically connecting with a dock, the dock comprising a network interface coupled to an internet, wherein when the portable electronic apparatus is electrically connected to the dock, the wireless communication module communicates with the internet via the micro controller unit and the network interface, such that at least one of the first and second electronic apparatuses is capable of communicating with the internet via the portable electronic apparatus and the dock.

13. The portable electronic apparatus of claim 12, wherein the dock is a charger.

14. The portable electronic apparatus of claim 13, further comprising a power management unit, and the dock further comprising a charging module, wherein when the portable electronic apparatus is electrically connected to the dock, the charging module charges the power management unit.

15. The portable electronic apparatus of claim 12, wherein the network interface is an Ethernet interface.

16. The portable electronic apparatus of claim 12, wherein the network interface communicates with the internet via a modem.
